(19) United States
(12) Patent Application Publication
(10) Pub. No.: US 2021/0145548 A1
(43) Pub. Date: May 20, 2021

(54) ORTHODONTIC TREATMENT APPARATUS

(71) Applicant: Christoph Von Mandach, Bözberg (CH)

(72) Inventor: Christoph Von Mandach, Bözberg (CH)

(21) Appl. No.: 17/046,656

(22) PCT Filed: Feb. 13, 2019
(86) PCT No.: PCT/EP2019/053473

§ 371 Date: Oct. 9, 2020

(30) Foreign Application Priority Data
Apr. 11, 2018 (CH) 00459/18

(51) Int. Cl. A61C 7/28

(52) U.S. Cl. CPC A61C 7/285; A61C 7/143

(57) ABSTRACT

An orthodontic treatment device includes: a receiving element fastenable in the jaw of a patient for receiving at least one wire arch portion (; and a securing element for securing the orthodontic wire arch in the receiving element. The receiving element has, a first or gingival receiving pocket for receiving a first or gingival wire arch portion and a second or occlusal receiving pocket for receiving a second or occlusal wire arch portion which together form a C-shaped receiving opening for the securing element an inserted state, the securing element The wire arch can be held in the gingival receiving pocket and placed on the bent inner surface of the gingival receiving pocket. The securing element has a first or gingival contact surface (adapted to a first or gingival wire arch portion for securing the wire arch in the gingival receiving pocket.

### TECHNICAL FIELD

The invention relates to an orthodontic treatment device comprising a receiving element which can be fastened in the jaw of a patient for receiving at least one wire arch portion of at least one orthodontic wire arch and a securing element for securing the at least one orthodontic wire arch in the receiving element.

### TECHNICAL BACKGROUND

Orthodontic treatment apparatuses in the form of brackets, which are fastened to the teeth to correct the position of the teeth, are available on the market in a very wide variety. They have what is known as a slot, in which a wire arch is held in place by a flap, by a vertically slidable gate, or by ligatures.

In order to achieve the desired corrective movement of the teeth, the wire arch must be shaped so that the teeth are pulled or pushed in the desired direction.

A good function and at the same time good aesthetics of the dentition is achieved if the teeth are in harmony with each other in respect of their individual orientation. Their orientation is divided into a first order, which relates to the course of the dental arch, or an ideal line which touches the outside of the teeth. This also includes the rotation of the tooth in relation to this line. The orientation with regard to the side view is attributed to the second order and is referred to as tilting or angulation. The orientation of the teeth transverse to the course of the arch is the third order and is referred to as buccolingual inclination or torque. The exact adjustment of the rows of teeth with wires and universal brackets, which are identical for all teeth, is very demanding. In order to simplify the treatment, sets of 28 different brackets have been on the market since 1970, which assign a separate bracket to each tooth. In the meantime, they have largely replaced the universal brackets. The sets are based on clinical-scientific studies of ideal dental arches and the creation of standards known as prescriptions. They assign a torque value, an angulation value and an in/out value to each bracket, which indicates the orientation of the slot relative to the base, which serves as an adhesive surface on the tooth. These brackets, which are manufactured according to a standard, are not adapted to the individual and therefore offer no guarantee that their settings of the teeth will ultimately meet the wishes of the patient and the dentist. Prescriptions have simplified the work on the patient as a whole, but in return they have considerably increased the workload for the manufacturer. Each type of bracket must be manufactured according to at least one prescription with different slot orientations and must be offered once as a complete set and once as a series of identical parts, especially since losses and defects of brackets in the range of 5% are considered normal. In 1955, the 0.022 inch×0.028 inch slot, which was usual at the time, was joined by the 0.018 inch×0.022 inch slot. Therefore, the brackets must always be offered in two versions. The great technical effort is hardly or not at all visible to the eye and the differentiation of the different brackets is only possible thanks to additional markings.

With brackets made of glass and ceramics (hybrid ceramics), identification is notoriously problematic. This includes an alarming susceptibility to mix-ups and incorrect placement.

In order for the dentist to keep track of the large number of brackets, one and the same bracket must be listed in the catalogues under different names and numbers. As a result, individual bracket types have up to 300 order items.

In order to avoid the problems described above, procedures have been developed since the year 2000 which take into account or calculate the torque, angulation and in/out values individually for each patient in order to be able to place each bracket individually (for example Orthorobot) or even manufacture them individually (for example Incognito, Insignia, Win). These procedures also include the production of transfer aids for placing the brackets in the patient's mouth and the pre-bending of the wires for the entire treatment using CAD/CAM and robots. The aim of these procedures is to simplify the treatments, shorten the duration of the treatment and reduce the working time during the checks. The value of these procedures has not yet been proven generally, but only in the very complicated lingual treatment, where the brackets are glued to the inside of the teeth for aesthetic reasons.

WO2015140026 in the name of the same applicant describes an orthodontic bracket comprising a base plate for fastening the bracket to a tooth, a gingival receiving pocket and an occlusal receiving channel. The occlusal receiving channel forms a hinged bearing for a flap which is pivotable over the base plate. An exchangeable insert can be engaged with the gingival receiving pocket and the occlusal receiving channel. On the side of the insert facing away from the base plate, two wire arch guide surfaces enclosing a right angle are formed, between which a wire arch with a rectangular cross-section—what is known as a flat wire—can be inserted. This flat wire is held in the inserted state by the pivotable flap on the insert or bracket. It is advantageous that a torque value can be set individually via the exchangeable insert without having to exchange the bracket attached to the tooth. However, the solution has the disadvantage that the possible angular range of the guide surfaces is limited. In addition, further elements are necessary for fastening the wire arch.

### SUMMARY OF THE INVENTION

One aspect of the invention relates to an orthodontic treatment appliance which is of simple design and can be used more easily and efficiently by the dentist. Another aspect relates to facilitating the fine adjustment of inclination and angulation compared to conventional methods and also to make it more precise.

The orthodontic treatment device comprises a receiving element which can be fastened in the jaw of a patient for receiving at least one wire arch portion of at least one orthodontic wire arch and a securing element for securing the at least one orthodontic wire arch in the receiving element. The receiving element comprises a base plate, a first or gingival receiving pocket for receiving a first or gingival wire arch portion and a second or occlusal receiving pocket for receiving a second or occlusal wire arch portion which together form a C-shaped receiving opening for the securing element. In an inserted state, the securing element is held in the C-shaped receiving opening. The first or gingival receiving pocket has an inner surface which is bent with a constant radius and, when the securing element is in the inserted state, the at least one wire arch can be held at least in the gingival receiving pocket and can be placed on the bent inner surface of the first or gingival receiving pocket. The securing element has a first or gingival contact surface, adapted to a first or gingival wire arch portion, for securing the at least one wire arch in the first or gingival receiving pocket. A first or gingival opening for a first or gingival wire arch is formed between the securing element and the pocket.

This basic form of the receiving element generally allows the assignment of different orthodontic functions by suitable design of the contact surface of the securing element and the selection of the wire arch, with all securing elements sharing the common feature that they have a first or gingival contact surface for securing the at least one wire arch in the first or gingival receiving pocket. The individual functions will be explained in more detail below. Depending on its function, the receiving element does not have to be replaced during treatment. The dimensions of the slots or guides for wire arches and sometimes even their orientation can be changed during treatment by simply replacing the securing elements.

The openings of the receiving pockets are directed towards each other and thus, together with the base plate, form the cross-sectionally C-shaped receiving opening for the securing element. The receiving element with its cross-sectionally C-shaped receiving opening is the central element here, into which at least one first or gingival wire arch can be inserted, which is then secured by means of the securing element, which has a contact surface adapted to a wire arch portion. In other words, the receiving element and the securing element together form a first or gingival recess, in which a first or gingival wire arch can be guided. The receiving element is open at the side, i.e. in the longitudinal direction of the receiving element. The longitudinal direction corresponds to the main direction in which the wire arch is guided.

For the fixing of round wires during first-order corrections, in particular pivotable securing elements are used, which are described in detail below. In very difficult cases or in difficult situations, second- and third-order corrections (angulation and torque) can then be made with insertable securing elements in the form of torque elements for even more precise adjustment of a tooth or a tooth arch segment. These elements are also described in detail below.

The two receiving pockets each form undercuts in the C shape (viewed perpendicular to the base plate), so that respective wire arches can also be guided loosely in the receiving pockets without being secured by the securing element. The opening of the C shape is dimensioned accordingly so that a wire arch and/or the securing element can be inserted from the front, i.e. from the side facing away from the base plate. Alternatively, the securing element can also be inserted laterally into the receiving opening, as is the case, for example, for the torque elements described further below.

Ideally, the locking element is held, in the inserted state, in a latching manner secured against rotation.

If the receiving element is used as a conventional bracket or as a lingual lock (also called a Goshgarian lock) for a lingual or palatal arch and is attached directly or indirectly to a tooth, the first receiving pocket is always a gingival receiving pocket, which is gingivally oriented when the receiving element is in the fastened state. Accordingly, the second receiving pocket is an occlusally oriented, occlusal receiving pocket.

In some embodiments, the first or gingival receiving pocket may be larger than the second or occlusal receiving pocket.

In some embodiments, an end region of the side wall of the first or gingival receiving pockets may be inclined inwards towards the base plate, i.e. the curvature of the inner surface is over 180°, preferably about 200° to 220°.

In some embodiments, an end region of the side wall of the second or occlusal receiving pockets may be inclined outwards away from the base plate, i.e. the curvature of the inner surface is less than 180°, preferably about 160° to 170°. The end region may have a linear region when viewed in cross-section, and the line of alignment of the end region may pass approximately through an apex region of the first or gingival receiving pocket.

In some embodiments, the second or occlusal receiving pocket may have an inner surface bent with a constant radius. The securing element can also have a second or occlusal contact surface adapted to a second or occlusal wire arch portion to secure the at least one wire arch or a second wire arch in the second or occlusal receiving pocket. Accordingly, in addition to the first or gingival opening for the first or gingival wire arch or wire arch portion, a second or occlusal opening or tunnel or a so-called tube for a second or occlusal wire arch or wire arch portion is then formed.

The orthodontic treatment device can be used accordingly to secure a first or gingival wire arch and optionally a separate second or occlusal wire arch. A single wire arch with a first or gingival and a second or occlusal wire arch portion—as for example with a palatal arch—can also be secured with the treatment device. In this case, the securing element engages directly in the two receiving pockets and is held in the receiving opening of the receiving element or it can be held indirectly in the receiving opening, for example by engaging under the two wire arch portions of a palatal arch.

In some embodiments, the securing element can have a first or gingival hinge portion which can be received in hinged fashion in the first or gingival pocket so that the securing element can be moved back and forth between a pivoted-out state and a pivot-in state. The first or gingival contact surface, which is adapted to a first or gingival wire arch portion, is designed as a recess in the hinge portion. The recess is arranged in such a way that, when the securing element is pivoted out, the wire arch can be inserted with the wire arch portion into the recess, and that, when the securing element is pivoted in, the wire arch portion is held between the first or gingival contact surface of the securing element and the inner surface of the first or gingival receiving pocket. The recess is preferably arranged eccentrically to a pivot axis of the securing element.

The pivotable securing elements are inserted into the C-shaped receiving opening at the front by the dentist and are clicked into place. They are closed by being pressed with a finger or any flat instrument. They are opened by a narrow, flat instrument that can be inserted and tilted between an occlusal incision in the receiving element and the securing element. The securing elements usually form two slots or guides for wire arches and thus usually provide space for two vertically separated round wires. Elastic bands can also be used instead of a wire. The inserts can be shaped differently and thus form different slot sizes. With this, and thanks to the previously unknown small size and compactness of the receiving elements or brackets, new, fine elastic wires can be used, which are also not yet common. Thanks to the matching of slot size and wire dimension, they are capable of correcting even the most pronounced misalignments to perfection.

In some embodiments, the receiving element can be a bracket that can be fastened to a patient's tooth and the securing element can be a torque element for setting a torque from the orthodontic wire arch to the bracket. The base plate, the gingival receiving pocket and the occlusal receiving pocket together form the receiving opening for the torque element; the torque element in the inserted state is received in the receiving opening so that it cannot rotate. The gingival contact surface functions as a torque transmission surface for exerting a torque from the wire arch to the bracket.

These insertable securing elements are intended for difficult cases or situations and are used at the earliest after the extensive adjustment of a row of teeth with pivotable securing elements and round wires. In other words, only if there is a need for treatment measures that cannot be handled or are difficult to handle using round wires. Before using insertable securing elements, the pivotable securing elements must be removed. Then, the wire is inserted first and only then are the insertable parts pushed laterally into the receiving elements. This of course increases the effort required for the following sessions and checks compared to the pivotable securing elements, especially since the latter only have to be opened and closed. However, the receiving elements themselves do not need to be replaced.

The insertable securing elements can be industrially prefabricated with sets of different torque values for different wire dimensions. This allows the dentist to carry out the fine adjustment with a wire of his choice and eradicates the need to use the extremely strong square wires just because, for example, conventional bracket slots require it. In addition, a blank for insertable securing elements can be produced and offered, which can be ground to individual requirements by the dentist directly during the session using a CAD/CAM grinding device.

The torque transmission surface is designed and arranged in such a way that the wire arch, which in the inserted state is in contact with the torque transmission surface, rests with one edge, preferably two adjacent edges, on the bent inner surface of the gingival receiving pocket or with only one side surface on the base plate in a manner prevented against rotation. The wire arch can be a flat wire with a rectangular cross-section or a wire with two opposite parallel surfaces and bevelled or rounded edges.

In some embodiments, the securing element has an occlusal shoulder with which the securing element, when in the inserted state, engages in the occlusal receiving pocket of the receiving element.

The torque element is used to set a torque from an orthodontic wire arch to an orthodontic bracket, the bracket comprising a base plate for fastening the bracket to a tooth, for example by direct bonding or indirectly by means of a band, a gingival receiving pocket and an occlusal receiving pocket, which together form a receiving opening for the torque element. The torque element can be pushed laterally into the bracket and, in the inserted state, is held in the receiving opening of the bracket such that it cannot rotate. The torque element has a torque transmission surface for exerting a torque from the wire arch to the bracket. The torque transmission surface is formed on one side or in a region of the torque element, which is enclosed by the bracket in the inserted state of the torque element, so that, in the inserted state of the torque element, the wire arch is held in a manner secured against rotation by the torque element and is guided between the torque element and the bracket. By means of the torque transmission surface, a gingival or base-side guide for a wire arch with two opposite parallel side surfaces, for example a flat wire of rectangular cross-section, is formed between the torque element and the bracket.

Further aids, such as so-called flaps or ligatures, are therefore not necessary to hold the wire arch, as the torque element also assumes the ligating function. In addition, torque values or inclination values, but also angulation values can be individually adjusted via the inclination and course of the torque transmission surface, for example on site with suitable equipment, as explained in detail below. A further advantage is that the brackets do not have to be oriented exactly with regard to inclination and angulation, but only with regard to the contour of the tooth surface. The setting of the correct inclination or the correct torque and the correct angulation is implemented according to the dentist's ideas and can be precisely adjusted by selecting or manufacturing a torque element with the desired torque and/or angulation value. With the torque element, the direction and dosage of the forces of the wire arch acting on the teeth can be set exactly. Another major advantage is that the torque elements can be provided for any wire dimensions and fine adjustments no longer have to be made with the strongest wires.

The openings of the receiving pockets are directed towards each other and thus, together with the base plate, form a receiving opening for the securing element, for example in the form of a torque element, which can be inserted laterally, i.e. in the longitudinal direction of the bracket or the longitudinal direction of the torque element, into the receiving opening. The longitudinal direction is therefore perpendicular to the gingival or occlusal direction.

In this inserted state, the torque element can be secured against falling out unintentionally, for example by means of integrally moulded locking elements, which engage in corresponding complementary locking means of the receiving element or bracket.

When the torque element is in the inserted state, i.e. when the torque element is inserted in the receiving opening of the bracket, it is enclosed gingivally, occlusally and on the base-plate side by the bracket. Only the side of the torque element facing away from the base plate is exposed and can have an operating opening through which the torque element can be inserted into the bracket using a suitable tool. Alternatively, the torque transmission element can have an operating handle instead of the operating opening.

In some embodiments, the torque element has a gingival shoulder and an occlusal shoulder, with which the torque element engages, respectively, in the gingival receiving pocket or in the occlusal receiving pocket of the retaining element or bracket in the inserted state.

In some embodiments, the torque transmission surface can be designed in such a way that a wire arch with two opposite parallel side surfaces, for example in the form of a flat wire, is guided directly in the torque element or indirectly in interaction with the bracket in such a way that the wire arch cannot rotate. The torque transmission surface therefore can be designed, for example, in the form of a torque transmission groove or torque transmission plane. The torque transmission surface is preferably directed gingivally, i.e. on the gingival side or in the gingival region of the torque element, so that the wire arch is guided in the region of the gingival receiving pocket. In this case, one torque transmission plane is sufficient and at least one, preferably two adjacent edges of the wire arch rest on the bent inner surface of the gingival receiving pocket. The desired torque can thus be set by selecting the angle of the torque transmission surface in relation to the base plate. If an orientation in the gingival direction is not possible or is not desired, the wire arch guide can also be displaced occlusally towards the base plate by means of a torque transmission groove. In this case, the wire arch rests on the base plate with only one side surface. A base-side arrangement of the torque transmission groove is particularly suitable for setting angulation values, as the wire arch should not be guided parallel to the longitudinal direction of the bracket.

The torque transmission surface can continuously define a torque value from minus (−) 60 to plus (+) 60 degrees, with values between −56 and +28 being usually used in practice. This torque value is determined or set on the basis of the angle between the torque transmission surface and the perpendicular to the base-side surface of the torque element or the fastening surface of the base plate when the torque element is in the inserted state.

In some embodiments, the torque transmission groove, for example for adjusting the angulation, can be located in the rear side of the torque element, i.e. on the base side in the side facing the base plates. When the torque element is in the inserted state, the torque transmission groove runs parallel to the base plate or the fastening surface of the base plate. Depending on the angulation to be corrected (mesially or distally), the torque transmission groove can be inclined in relation to the longitudinal direction of the torque element or bracket by minus (−) 15 degrees to plus (+) 15 degrees, with values between −12 and +12 being usually used in practice.

In some embodiments, the torque element on the occlusal side can be designed in such a way that, when inserted between the torque element and the base plate, an occlusal guide or tunnel or a so-called tube is formed in the occlusal receiving pocket and can receive a round wire, for example. In this way, the torque element can also be used to close gaps between two teeth, for example, without having to exchange the bracket. The torque element can be designed with or without a torque transmission surface.

In some embodiments, a side wall of the receiving element forming the first or gingival receiving pocket or a side wall of the receiving element forming the second or occlusal receiving pocket may have an extension on both sides, which reaches as far as the opposite side wall of the opposite receiving pocket and is fastened there. In this way, the receiving element can be used as a lingual lock for a lingual arch, although this is already possible with an unmodified receiving element.

In some embodiments, the torque transmission element can be made of plastic, for example Crastin® (a polybutylene terephthalate), metal or ceramic, for example zirconium dioxide.

In some embodiments, a side wall of the receiving element forming the first or gingival receiving pocket and/or a side wall of the receiving element forming the second or occlusal receiving pocket may comprise an indentation for a gingival and/or occlusal detent lug of the securing element, the indentation preferably being arranged centrally in the longitudinal direction of the receiving element.

The invention further relates to a treatment apparatus comprising a plurality of orthodontic treatment devices and at least one wire arch. In combination with digital technology and a simple precision grinding machine, the described receiving and securing elements make it possible to produce individualised securing elements, in particular the torque elements, directly on the patient's chair. Torque values from −56° to +28° in combination with angulation values of up to ±12° can be selected as required.

The invention further relates to a method for producing a torque element described above for the individual adjustment of a torque transmission from an orthodontic wire arch to an orthodontic bracket. The method comprises the following steps: (a) providing a blank of the torque element which has a gingival region which, when the blank is in the inserted state, approximately completely fills the gingival receiving pocket of the bracket; (b) determining the desired orientation of the torque transmission surface on the basis of an actual and a desired tooth position; (c) machining the blank in order to obtain the torque element with the desired orientation and shape of the torque transmission surface by means of a separating manufacturing process.

In some embodiments, the desired orientation of the torque transmission surface can be determined by taking into account the effective positioning of the bracket on a tooth. In this way, for example, inaccuracies in the fixing of the brackets, for example adhesive errors, can be compensated.

The invention further relates to a manufacturing device for producing a torque element described above according to the above method. The manufacturing device comprises a computer program for calculating the desired orientation of the torque transmission surface on the basis of a digitised three-dimensional model of the dentition of a patient and a manufacturing plant for producing the torque element with the desired torque transmission surface from a blank of a torque element. Alternatively, the torque transmission element can be manufactured by means of additive manufacturing methods.

### BRIEF DESCRIPTION OF THE DRAWINGS

The invention will be explained in further detail below by means of embodiments in conjunction with the drawing(s), in which:

FIG. 1 shows a perspective view of a receiving element with a C-shaped receiving opening for a securing element;

FIG. 2 shows a perspective view of a torque element for the receiving opening in a bracket according to FIG. 1;

FIG. 3 shows a perspective view of a torque element in the assembled state;

FIG. 4 shows a side view of the bracket with torque element according to FIG. 3;

FIGS. 5A and 5B show side views of variants of a torque element with different torque values;

FIG. 6 shows a perspective view of a torque element for adjusting the angulation;

FIG. 7 shows a plan view of the base side of the torque element according to FIG. 6;

FIGS. 8A-8C show a torque element with torque transmission plane in a perspective view from the front (FIG. 8A), in a perspective view of the base plate (FIG. 8B), and in a front view (FIG. 8C);

FIG. 9 shows a side view of the torque element from FIGS. 8A-8C in the inserted state;

FIG. 10A-10J show a side view of a torque element with torque transmission plane with different torque values;

FIG. 11 shows a perspective view of a treatment apparatus on a tooth,

FIGS. 12A-12C show a perspective view (FIG. 12A) and a side view of another variant of the torque transmission element (FIG. 12B) and in the inserted state (FIG. 12C);

FIGS. 13A and 13B show a receiving pocket element with swivelling securing element in the swivelled out state in a side view (FIG. 13A) and in a perspective view (FIG. 13B);

FIGS. 14A and 14B show the receiving element with pivotable securing element from FIGS. 13A and 13B in the pivoted-in state in a side view (FIG. 14A) and in a perspective view (FIG. 14B);

FIG. 15 shows a receiving element and a securing element for forming a lingual lock;

FIG. 16A-16D show variants of a temporary bone implant with receiving element; and

FIG. 17 shows a band with receiving element.

### EMBODIMENTS OF THE INVENTION

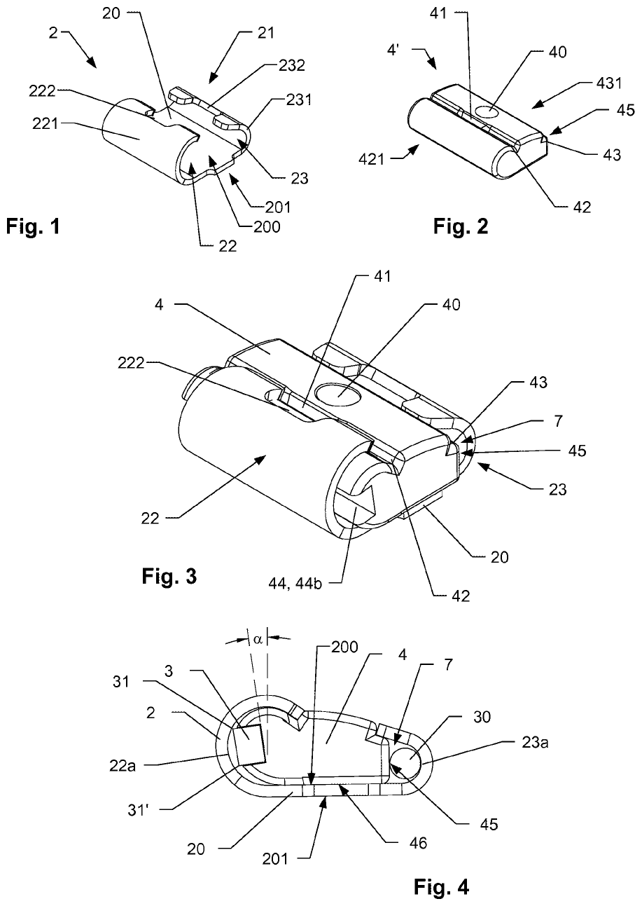

FIG. 1 shows a perspective view of a bracket-like receiving element 2 with a cross-sectionally C-shaped receiving opening 21 (also known as a slot) for receiving a securing element. The receiving element 2 comprises a base plate 20 with a substantially flat frontal base surface 200. The term ‘frontal’ means the side facing away from the patient's tooth or palate and accessible for the insertion of a wire arch. In the case of the bracket, the base plate also serves to fasten the bracket to a tooth of a patient to be treated. As a rule, the base plate 20 has a substantially flat fastening surface 201 on the rear side. However, the fastening surface 201 can also be adapted to a tooth shape. The receiving element 2 further comprises a gingival receiving pocket 22 and an occlusal receiving pocket 23, the openings of which face each other and which, together with the base plate 20 or the base surface 200, form a receiving opening 21 for a securing element. This receiving opening 21 is formed on the front side, i.e. on the side of the receiving element 2 that is opposite the fastening surface 201. In the embodiment shown, the gingival receiving pocket 22 and the occlusal receiving pocket 23 are formed by bent side walls 221, 231 adjoining the base plate 20 and each have an inner surface 22a, 23a bent with a constant radius.

The receiving opening 21 is open on both sides in the longitudinal direction of the receiving element 2. The longitudinal direction of the receiving element 2 is the direction which substantially corresponds to the longitudinal direction of an inserted wire arch (without angulation). The side walls 221, 231 can have indentations 222, 232 at their free ends or end regions, in which detent lugs of a securing element can latch or engage. In the embodiment shown, the gingival receiving pocket 22 and the occlusal receiving pocket 23 have a cross-section that is substantially circular sector-shaped.

FIG. 2 shows a perspective view of a blank 4′ of a locking element in the form of a torque element 4. This blank 4′ is the output element, which can be provided with a torque transmission surface 44, 44a, 44b, for example directly by the treating dentist, in order to obtain a ready-to-use torque element 4. Examples of such torque elements 4 are shown in FIGS. 3 to 10.

The blank 4′ or the torque element 4 has a gingival shoulder 42 and an occlusal shoulder 43, with which the torque element 4 engages, respectively, in the gingival receiving pocket 22 or in the occlusal receiving pocket 23 when in the inserted state. To secure the torque element 4 against slipping out, it may have a detent lug 41 gingivally and/or occlusally. FIG. 2 shows a gingival detent lug 41, which can engage in the corresponding indentation 222 in the bracket 2. Furthermore, the torque element 4 can have an operating opening 40 on the side facing away from the receiving element 2 or bracket. The torque element 4 can thus be pushed laterally into the receiving opening 21 of the receiving element 2 using a suitable tool which engages in the operating opening 40.

The gingival side 421 of the blank 4′ is substantially complementary to the gingival receiving pocket 22. The occlusal side 431 of the blank 4′ can—as shown in FIG. 4—have a second or occlusal contact surface 45, which is designed in such a way that, in the inserted state between the torque element 4 and the receiving element 2, a receiving opening or guide 7 is formed for a second or occlusal wire arch in the form of a round wire 30 (see FIG. 4). If only such a round wire 30 is used, the blank 4′ does not have to be machined to form a torque transmission surface 44, 44a, 44b. Such a securing element can also be used to secure a rubber thread instead of a wire in the guide 7, for example to close gaps between teeth.

If the securing element or torque element 4 is to be used to transmit a torque from a first or gingival wire arch 3 to the receiving element or bracket 2, the torque element 4 has a prefabricated torque transmission surface 44, 44a, 44b or a torque transmission surface 44, 44a, 44b individually manufactured by the treating dentist. This torque transmission surface 44, 44a, 44b is arranged and designed on one side or in one region of the torque element 4 in such a way that it is enclosed by the receiving element or bracket 2 when the torque element 4 is in the inserted state, so that a gingival or base-side guide is formed for the first or gingival wire arch 3. The first or gingival wire arch 3 is held in a manner secured against rotation by the torque element 4 and is guided between the torque element 4 and the bracket 2. This is clearly visible in FIGS. 3 and 4.

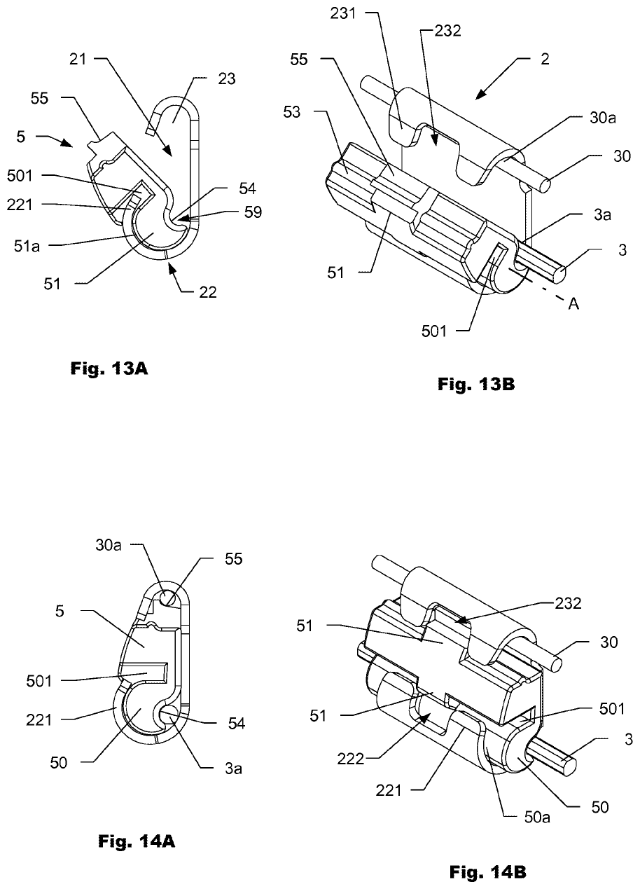

FIG. 3 now shows a perspective view of the securing element or torque element 4 inserted in the receiving element or bracket 2 with a torque transmission surface, which in the variant shown is designed as a torque transmission groove 44b. FIG. 4 shows a side view of it with inserted first or gingival wire arch 3 and inserted second or occlusal wire arch 30 in the form of a round wire. To transmit torque, the first or gingival wire arch is a flat wire with a rectangular cross-section or a wire with two opposite parallel surfaces and bevelled or rounded edges (see FIG. 4 and FIG. 13B). The first or gingival wire arch 3 rests with one side surface against the torque transmission surface and with one or two adjacent edges 31, 31′ against the round inner surface of the first or gingival receiving pocket 22.

In the variant of the torque element 4 from FIGS. 3 and 4, the so-called torque value at (alpha) is approximately plus (+) 8 degrees. This is determined on the basis of the angle between the torque transmission surface and the perpendicular to the base-side surface 46 of the torque element 4 or the fastening surface 201 of the base plate 20 of the bracket 2, as shown in FIGS. 4, 10A and 10F.

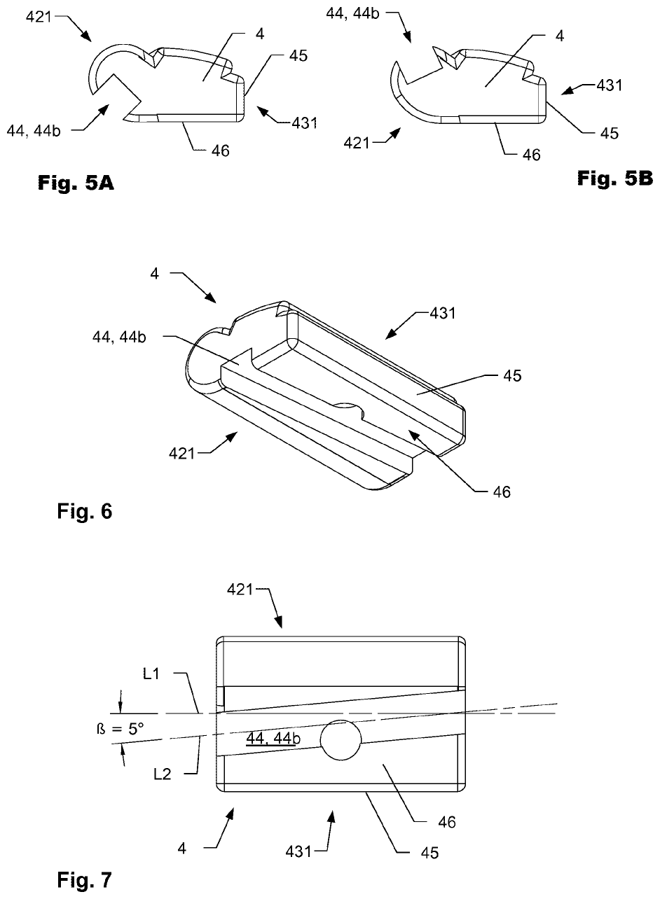

FIG. 5A and FIG. 5B each show a side view of a torque element 4 with torque transmission groove 44b, which have different torque values. In the variant in FIG. 5A, the torque transmission groove is arranged gingival and on the base side and has a torque value of minus (−) 45 degrees. In the variant in FIG. 5B, the torque transmission groove is arranged gingivally and facing away from the base side and has a torque value of plus (+) 65 degrees. These torque values of a torque element can be selected accordingly over a very wide range from −60 to +60 degrees as required.

FIG. 6 shows a perspective view of a torque element 4 for setting or correcting the angulation of a tooth. FIG. 7 shows a plan view of the base side of the torque element according to FIG. 6. This variant of the torque element 4 has a torque transmission groove 44b on the base side 46 or on the side of the torque element 4 that faces the base plate 20 in the inserted state. In the embodiment shown, the torque transmission groove 44b defines an angulation value R of approximately 5 degrees (see FIG. 7). This is determined by the angle between the longitudinal direction L2 of the torque transmission groove 44b and the longitudinal direction L1 of the torque element 4 or the bracket 2.

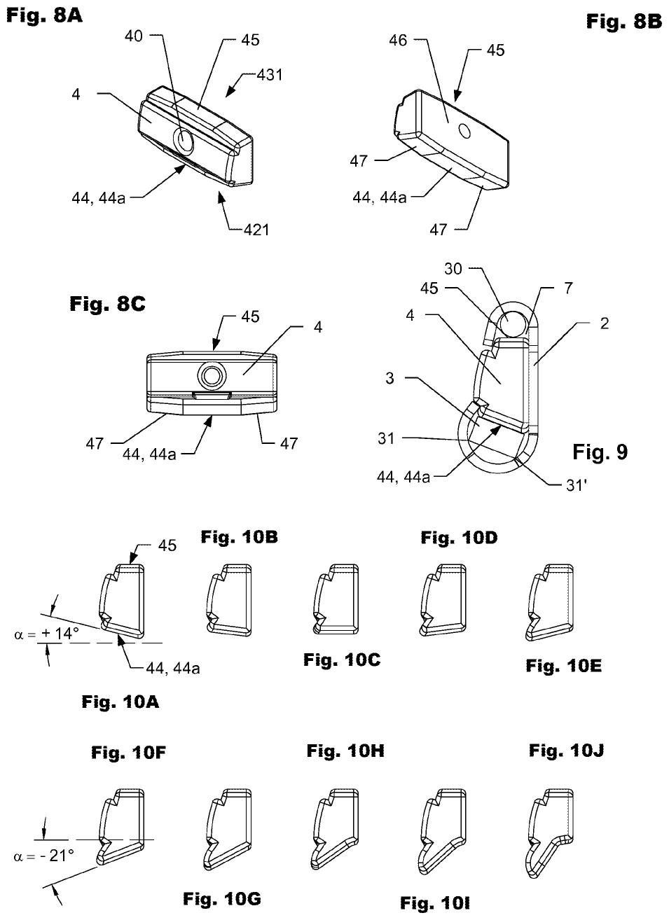

FIGS. 8, 9 and 10 show torque elements 4 of which the torque transmission surface 44 is designed as torque transmission plane 44a. The torque transmission plane 44a is formed in each case on the gingival side 421 of the torque element 4 with the desired torque value α (alpha). The torque element 4 can have a bevel 47 on both sides of the torque transmission plane 44a, as seen in the longitudinal direction, so that the torque element 4 can be inserted more easily into the receiving opening 21 of a receiving element or bracket 2. For the torque element 4 in FIGS. 8 and 9, the torque value α (alpha) is +21 degrees. For the torque elements 4 in FIGS. 10A to 10J, the torque value α (alpha) is, respectively, +14, +7, 0, −7, −14, −21, −28, −35, −42, and −49 or approximately −56 degrees. FIG. 9 also shows the first or gingival wire arch 3 in the form of a flat wire, which rests with one side surface on the first or gingival contact surface or torque transmission plane 44a and with two adjacent edges 31, 31′ of the flat wire on the first or gingival inner surface 22a of the first or gingival receiving pocket 22. The inner surface 22a, which is bent with a constant radius, allows a continuous adjustment of the torque value according to the angle of the torque transmission surface 44a, more specifically without having to replace or change the receiving element 2.

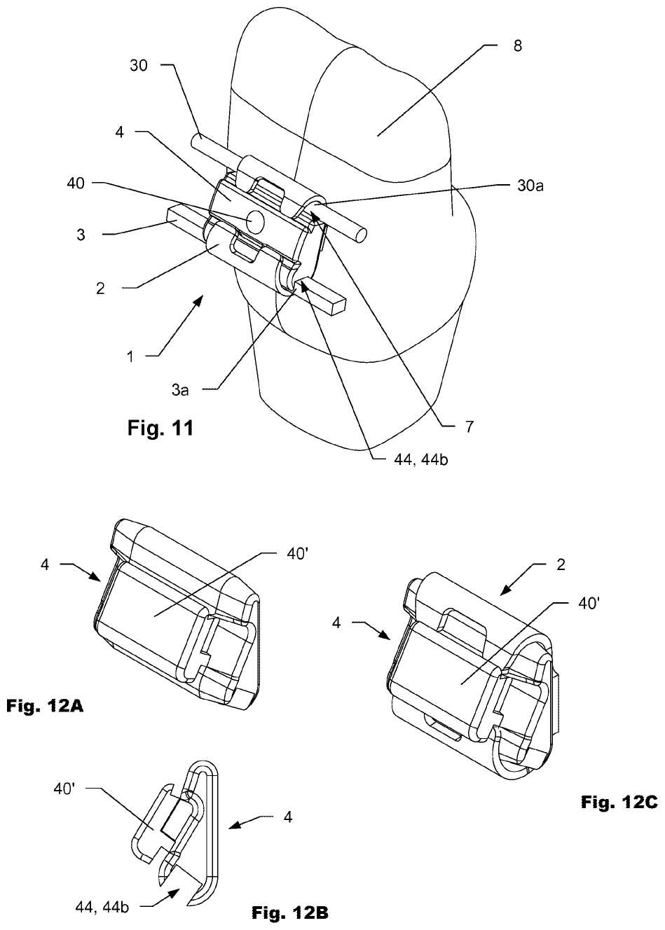

FIG. 11 shows a perspective view of a treatment apparatus comprising a bracket 2, a torque element 4 according to FIG. 3 or 4, a wire arch or flat wire 3 and a round wire 30. The bracket 2 is fastened with the fastening surface on a tooth 6. The torque element 4 has a torque transmission groove 44b and is inserted in the bracket 2. The first or gingival wire 3 is held in the torque transmission groove 44b between torque element 4 and bracket 2 in a manner secured against rotation. The second or occlusal round wire 30 is arranged in an occlusal guide 7 between torque element 4 and bracket 2. Such a securing element can also be used to secure a rubber thread instead of a wire in the occlusal guide 7, for example to close gaps between teeth.

FIGS. 12A, 12B and 12C show a further variant of the torque element 4, which, in contrast to the variants described above, has an operating handle 40′ instead of the operating opening 40 for pushing the torque element into and out of the receiving opening 21 of the receiving element 2.

FIGS. 13A and 13B show a receiving element 2 with a pivotable securing element 5 in the pivoted-out state. FIGS. 14A and 14B show the pivotable securing element from FIG. 13 in the pivoted-in position. The pivotable securing element has a first or gingival hinge portion 50. The hinge portion 50 is designed in such a way that it can be received in hinged fashion in the first or gingival receiving pocket 22 and can thus be moved back and forth between a pivoted-out state (FIGS. 13A and 13B) and a pivoted-in state (FIGS. 14A and 14B). In the pivoted-in state, the securing element 5 is received, preferably in a latched manner, in the C-shaped receiving opening 21 of the receiving element 2, which has the form already described above.

In other words, a receiving element 2 fastened to a tooth 8 does not have to be changed in order to assign different functions to the orthodontic treatment device with regard to the direction of the tooth correction. This is done via the securing element. The pivotable securing element 5 is used to hold a first or gingival wire arch 3 in the form of a round wire in the gingival receiving pocket 22.

For this purpose, the pivotable securing element 5 has a first or gingival contact surface 54 which is matched to a first or gingival wire arch portion 3a of the wire arch 3. This contact surface is designed as a recess 59 in the hinge portions 50 and is arranged in such a way that when the securing element 5 is pivoted out, the wire arch 3 can be inserted with the wire arch portion 3a into the recess 59 between the securing element and the receiving element. In the pivoted-in state of the securing element 5 (see FIGS. 14A and 14B), the wire arch portion 3a is held between the first or gingival contact surface 54 of the securing element 5 and the inner surface 22a of the first or gingival receiving pocket 22.

As shown in the embodiment shown, the recess 50 can be arranged eccentrically to the pivot axis A of the securing element 5.

As shown in FIGS. 13A and 13B and 14A and 14B, the securing element 5 can also have a shoulder 53 in the form of a bead on the side 431 opposite the hinge portion 50, so that the securing element 5 engages in the second or occlusal receiving pocket 23 or under its end region of the side wall 231 in the pivoted-in state. In addition, the securing element 5 can be provided with one or two frontal detent lugs 51, which engage in corresponding indentations 222, 232 of the receiving element 2 (see for example FIG. 1) and prevent lateral displacement of the securing element 5 in the longitudinal direction both in the pivoted-in and pivoted-out state.

The securing element 5 shown in FIGS. 13A and 13B and 14A and 14B has lateral recesses 501 in the region of the hinge portion, into which the end region of the first or gingival side wall 221 is inserted in the pivoted-out state. Accordingly, the detent lug 51 and the indentation 222 of the gingival side wall 221 are designed in such a way that a pivoting out by approximately 45 degrees is possible. A lateral displacement of the securing element 5 is prevented and the first or gingival wire arch 3 can be inserted into the first or gingival receiving pocket 22 without any difficulty. In order to secure the wire arch 30, only the securing element 5 is then pivoted in.

As shown in FIGS. 13A and 13B and FIGS. 14A and 14B, the securing element can optionally have a second or occlusal contact surface 55 for securing a second or occlusal wire arch 30 in the second or occlusal receiving pocket 23 of the receiving element 2, so that when the securing element 5 is pivoted in, a second or occlusal guide 7 is formed for the second or occlusal wire arch 30, similarly to the torque transmission element described above. Such a securing element can also be used to secure a rubber thread instead of a wire in the occlusal guide 7, for example to close gaps between teeth.

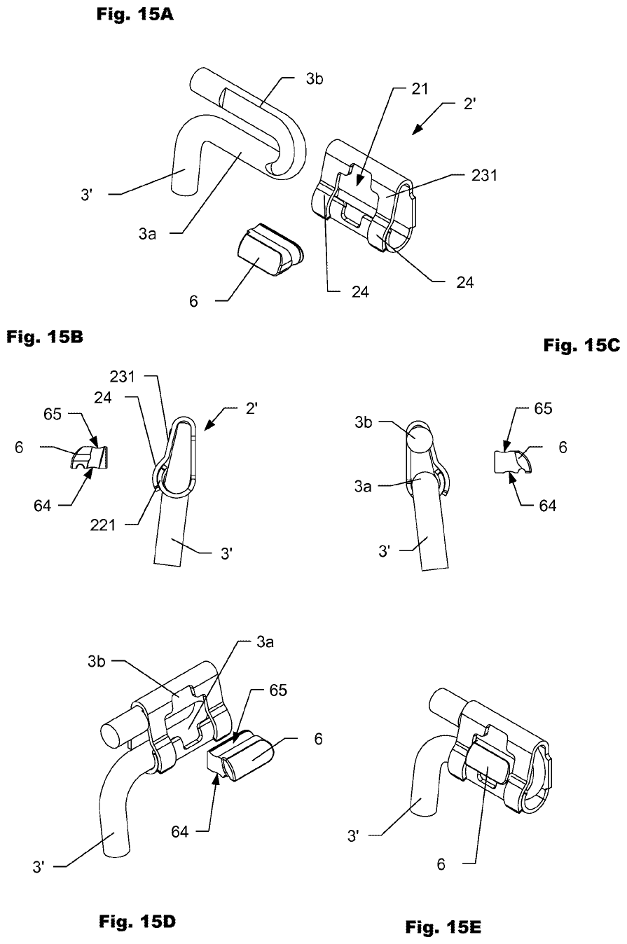

FIGS. 15A to 15E shows an orthodontic treatment device with a variant of the receiving element 2 and a variant of the securing element 6 for forming a lingual lock for a lingual arch. FIGS. 15A to 15E show the treatment device in various views and states: in (a) in an exploded perspective view, in (b) in a side view with the lingual arch 3′ inserted, viewed against the direction of insertion; in (c) in a side view with the lingual arch 3′ inserted, viewed in the direction of insertion; in (d) a perspective view with the lingual arch 3′ inserted; and in (e) a perspective view with the securing element 6 inserted.

The receiving element 2′ differs from the receiving element 2 from FIG. 1 in that the end region of the second or occlusal side wall 231 of the second or occlusal receiving pocket 23 has extensions 24 on both sides in the form of a tab, which extend as far as the end region of the first or gingival side wall 221 of the first or gingival receiving pocket 22 and are preferably fastened there. The C-shaped receiving opening into which the securing element 6 can be inserted to secure the lingual arch 3′ is still formed in the centre.

The lingual arch 3′ has a bent end with a first or gingival wire arch portion 3a and a second or occlusal wire arch portion 3b, which are parallel to each other. The second or occlusal wire arch portion 3b is preferably located closer to the end of the lingual arch.

The lingual arch 3′ can be inserted with these two wire arch portions 3a, 3b laterally into the receiving opening 21 of the receiving element 2′. Preferably, the first or gingival receiving pocket 22 is larger than the second or occlusal receiving pocket 23, so that a relatively thick lingual arch 3′ can also be used, which is then only slightly ground in the bend and on the second or occlusal wire arch portion 3b, so that it can be inserted into the two receiving pockets 22, 23 with an interlocking fit on the whole (see FIG. 15A).

The two wire arch portions 3a, 3b are spaced apart from each other in such a way that the securing element 6 can be inserted between the two wire arch portions 3a, 3b into the receiving opening 21 of the receiving element 2′, so that it clamps the two wire arch portions 3a, 3b and secures them against sliding out laterally. The securing element 6 for this purpose has a first or gingival contact surface 64 and a second or occlusal contact surface 65.

In order to insert the securing element 6 into a receiving element 2 shown in FIG. 1, it can have a detent lug similar to the securing elements described above, which engages in an indentation in the locating element.

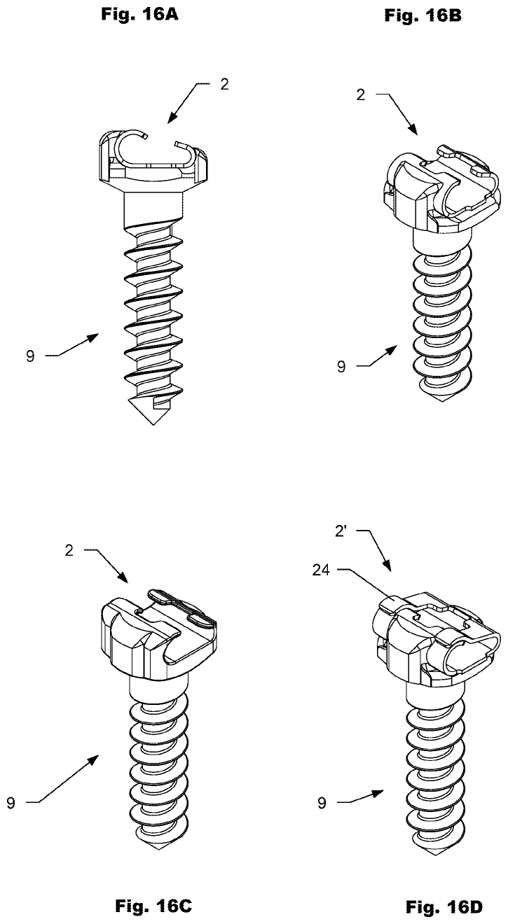

The receiving element 2, 2′ with the C-shaped receiving opening 21 can also be designed as a temporary bone implant 9, for example with a screw thread, as shown in FIGS. 16A to 16D. Here, too, there is the possibility of using the receiving element 2, 2′ in its simplest form (FIG. 16A) or with extensions 24 on both sides (FIG. 16D). The advantages compared to conventional orthodontic implants are the low overall height, the general usability for many different purposes, and the problem-free and simple assembly and disassembly of wires or apparatuses with the securing elements 4, 5, 6 described above. The temporary bone implant 9 can be designed in one piece (FIG. 16A) or in a number of pieces (FIG. 16A, 16B, 16D) together with the receiving element.

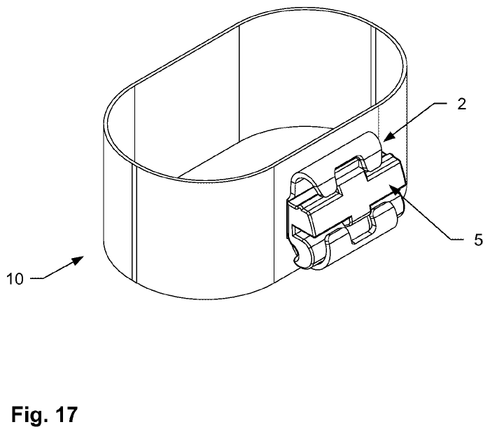

FIG. 17 shows a band 10 with a receiving element 2 fastened to it and an inserted pivotable securing element 5.

### LIST OF REFERENCE SIGNS

1 treatment apparatus
2 receiving element, bracket
2′ receiving element, lingual lock
20 base plate
200 frontal base surface
201 rear-side fastening surface
21 receiving opening
22 first or gingival receiving pocket
22a first or gingival inner surface
221 side wall, end region
222 indentation
23 second or occlusal receiving pocket
23a second or occlusal inner surface
231 side wall, end region
232 indentation
24 extension
3 first or gingival wire arch, round wire, flat wire
3′ lingual arch
3a first or gingival wire arch portion
3b second or occlusal wire arch portion
30 second or occlusal wire arch, round wire
30a second or occlusal wire arch portion
31, 31′ edge
4 securing element, torque element
4′ blank of a torque element
40 operating opening
40′ operating handle
41 detent lug
42 gingival shoulder
421 gingival side
43 occlusal shoulder
431 occlusal side
44 first or gingival contact surface, torque transmission surface
44a torque transmission plane
44b torque transmission groove
45 second or occlusal contact surface
46 base side, base-side surface
47 bevel
5 securing element (pivotable)
50 hinge portion
501 lateral recess
51 detent lug
53 occlusal shoulder
54 first or gingival contact surface
55 second or occlusal contact surface
59 recess
6 securing element for lingual lock
64 first or gingival contact surface
65 second or occlusal contact surface
7 occlusal guide for round wire
8 tooth
9 temporary bone implant
10 band
A pivot axis
L1 longitudinal direction of the torque element
L2 longitudinal direction of the torque transmission groove
α (alpha) torque value
β (beta) angulation value

1-21. (canceled)

22. An orthodontic treatment device comprising a receiving element fastenable in a jaw of a patient for receiving at least one wire arch portion of at least one orthodontic wire arch and a securing element for securing the at least one orthodontic wire arch in the receiving element, wherein the receiving element comprises a base plate, a first or gingival receiving pocket for receiving a first or gingival wire arch portion and a second or occlusal receiving pocket for receiving a second or occlusal wire arch portion which together form a C-shaped receiving opening for the securing element, the securing element, in an inserted state, being held in the C-shaped receiving opening, the first or gingival receiving pocket having an inner surface which is bent with a constant radius and, when the securing element is in the inserted state, the at least one wire arch being holdable at least in the gingival receiving pocket and being able to be placed on the bent inner surface of the first or gingival receiving pocket, and the securing element having a first or gingival contact surface, adapted to a first or gingival wire arch portion, for securing the at least one wire arch in the first or gingival receiving pocket.

23. The orthodontic treatment device according to claim 22, wherein the second or occlusal receiving pocket has an inner surface which is bent with a constant radius.

24. The orthodontic treatment device according to claim 22, wherein the securing element has a second or occlusal contact surface adapted to a second or occlusal wire arch portion for securing the at least one wire arch in the second or occlusal receiving pocket.

25. The orthodontic treatment device according to claim 22, wherein the first or gingival receiving pocket (22) is larger than the second or occlusal receiving pocket (23).

26. The orthodontic treatment device according to claim 22, wherein an end region of the side wall of the first or gingival receiving pocket is inclined inwardly towards the base plate and/or an end region of the side wall of the second or occlusal receiving pocket is inclined outwardly away from the base plate.

27. The orthodontic treatment device according to claim 22, wherein an end region of the second or occlusal receiving pockets is linear in cross-section, and the line of alignment of the end region leads approximately through an apex region of the first or gingival receiving pocket.

28. The orthodontic treatment device according to claim 22, wherein the securing element comprises a first or gingival hinge portion which is receivable in hinged fashion in the first or gingival receiving pocket so that the securing element is movable back and forth between a pivoted-out state and a pivoted-in state, the first or gingival contact surface adapted to a first or gingival wire arch portion being formed as a recess in the hinge portion, the recess being arranged in such a way that the wire arch can be inserted with the wire arch portion into the recess when the securing element is in the pivoted-out state, and that the wire arch portion is held between the first or gingival contact surface of the securing element and the inner surface of the first or gingival receiving pocket when the securing element is in the pivoted-in state.

29. The orthodontic treatment device according to claim 28, wherein the recess is arranged eccentrically to a pivot axis of the securing element.

30. The orthodontic treatment device according to claim 22, wherein the securing element has an occlusal shoulder with which the securing element engages in the occlusal receiving pocket of the receiving element when in the inserted state.

31. The orthodontic treatment device according to claim 22, wherein the receiving element is a bracket which can be fastened to a tooth of the patient, and in that the securing element is a torque element for setting a torque from the orthodontic wire arch to the bracket or the tooth, the base plate, the gingival receiving pocket and the occlusal receiving pocket together forming the receiving opening for the torque element, the torque element, in the inserted state, being received in the receiving opening in a manner secure against rotation, and the gingival contact surface being a torque transmission surface for exerting a torque from the wire arch to the bracket, the torque transmission surface being designed and arranged in such a way that the wire arch, which in the inserted state rests on the torque transmission surface, rests with one edge, preferably two adjacent edges, on the bent inner surface of the gingival receiving pocket or with only one side surface on the base plate in a manner secure against rotation.

32. The orthodontic treatment device according to claim 31, wherein the torque element has a gingival shoulder and an occlusal shoulder with which the torque element engages, in the inserted state, in the gingival receiving pocket or in the occlusal receiving pocket of the receiving element, respectively.

33. The orthodontic treatment device according to claim 31, wherein the torque transmission surface is designed in the form of a torque transmission plane or torque transmission groove.

34. The orthodontic treatment device according to claim 31, wherein the torque transmission surface is formed on the gingival side of the torque element.

35. The orthodontic treatment device according to claim 31, wherein the torque transmission groove is arranged in the side facing the base plate and, in the inserted state of the torque element, runs parallel to the base plate and is inclined by minus (−) 10 to plus (+) 10 degrees with respect to a longitudinal direction of the torque element or of the bracket.

36. The orthodontic treatment device according to claim 31, wherein the torque element on the occlusal side is designed in such a way that, when the torque element is inserted, a guide for receiving a round wire is formed in the occlusal receiving pocket.

37. The orthodontic treatment device according to claim 22, wherein a side wall forming the first or gingival receiving pocket or a side wall of the receiving element forming the second or occlusal receiving pocket has an extension on both sides, which extends as far as the opposite side wall of the opposite receiving pocket and is fastened there.

38. The orthodontic treatment device according to claim 22, wherein the securing element is made of plastic, metal or ceramic, preferably zirconium dioxide.

39. The orthodontic treatment device according to claim 22, wherein a side wall of the receiving element forming the first or gingival receiving pocket and/or a side wall of the receiving element forming the second or occlusal receiving pocket comprises an indentation for a gingival and/or occlusal detent lug of the securing element, the indentation preferably being arranged centrally in the longitudinal direction of the receiving element.

40. A treatment apparatus comprising a plurality of the treatment devices according to claim 22 and at least one wire arch.

41. A method for producing the torque element of the treatment device according to claim 31 for individual adjustment of a torque transmission from an orthodontic wire arch to an orthodontic bracket; the method comprising:
a. providing a blank of the torque element, which has a gingival region which, when the blank is in the inserted state, substantially completely fills the gingival receiving pocket of the bracket;
b. determining the desired orientation of the torque transmission surface on the basis of an actual and a desired tooth position;
c. machining the blank in order to obtain the torque element with the desired orientation and shape of the torque transmission surface by a separating manufacturing process.

42. A manufacturing device for producing the torque element by the method according to claim 41, comprising a computer program product for calculating the desired orientation of the torque transmission surface on the basis of a digitized three-dimensional model of the dentition of a patient and a manufacturing plant for producing the torque element with the desired torque transmission surface from a blank of a torque element.
